(19) United States
(12) Patent Application Publication
(10) Pub. No.: US 2015/0267869 A1
(43) Pub. Date: Sep. 24, 2015

(54) WATER DISPENSER

(71) Applicant: KABUSHIKI KAISHA COSMO LIFE, Hyogo (JP)

(72) Inventor: Yoshinori Orita, Hyogo (JP)

(21) Appl. No.: 14/436,111

(22) PCT Filed: Sep. 26, 2013
(86) PCT No.: PCT/JP2013/076062

§ 371 Date: Apr. 16, 2015

(30) Foreign Application Priority Data
Oct. 22, 2012 (JP) 2012-232775

(51) Int. Cl. F17D 1/14

(52) U.S. Cl. CPC F17D 1/14

(57) ABSTRACT

A water dispenser is provided which includes a slide table and in which a raw water container is placed at a position lower than that of a temporary water storage tank. This water dispenser includes a penetration rod configured to be inserted from below and to project into the raw water container to allow communication between the raw water container and a water supply passage. By placing a cover over the raw water container placed on a container supporting portion of the slide table, falling of dust in the vicinity of the container supporting portion can be prevented. Further, even in cases where a side peripheral portion of the raw water container collapses unevenly, the cover prevents the collapsed portion of the side peripheral portion from protruding into spaces behind front end portions of side plates of the housing.

### TECHNICAL FIELD

The present invention relates to a water dispenser in which water transferred to a temporary water storage tank from a replaceable raw water container in advance can be discharged as drinking water.

### BACKGROUND ART

Water dispensers allow discharging of water controlled to a certain temperature in a temporary water storage tank through a water discharge passage, when a user operates a lever or a cock of a water dispenser to open a valve, so that the discharged water can be poured into a cup or the like of the user.

Among these, a water dispenser is known in which a raw water container is placed at a position lower than that of a temporary water storage tank. In this type of water dispenser, when a slide table is pulled forward from a drawer space provided at the lower portion of a housing in order to replace the raw water container which has been used up with a new one, a container supporting portion is exposed to the exterior of the housing, and when the new raw water container has been placed on the container supporting portion from above, the slide table can be pushed back into the housing. This allows an operator to carry out the replacement of the container with ease, without lifting up the heavy and new raw water container. Raw water in the raw water container placed at the lower portion of the housing is pumped up into the temporary water storage tank by a pump disposed in a water supply passage. When the water level in the temporary water storage tank falls to a predetermined lower limit, the pump is actuated automatically, and supplies water to the temporary water storage tank. At this time, if a sensor monitoring the status of the water being pumped detects that there is no more water available to be pumped out, a control unit actuates a notification device to notify the user that the raw water container needs to be replaced (below-identified Patent Document 1).

In the water dispenser disclosed in Patent Document 1, the raw water container is placed on the slide table with its container mouth facing upward. One end of the water supply passage is configured to be inserted into the raw water container through the container mouth. The housing includes right and left side plates defining the drawer space, and the front end portions of the side plates are bent so as to face each other in order to increase the rigidity of the housing.

The raw water container used in this water dispenser is a collapsible container or a rigid container. The collapsible container includes a side peripheral portion capable of collapsing naturally as the amount of water remaining in the container decreases. Since the side peripheral portion of the raw water container collapses naturally to reduce the volume of the raw water container, there is no need to squash the raw water container when the container is disposed of. In addition, since it is not necessary to insert the water supply passage deep into the raw water container, the sanitation of the water dispenser can be well maintained. On the other hand, the rigid container is excellent in recycling efficiency, since it hardly collapses naturally and has a shape retention capability sufficient to allow the reuse of the raw water container after raw water in the raw water container is fully used. In recent years, use of a collapsible container as the raw water container is increasing, focusing more on sanitation.

### PRIOR ART REFERENCE(S)

### Patent Document(s)

Patent Document 1: JP 2001-153523 A (paragraphs 0021 and 0022, and FIGS. 2 and 3 in particular)

### SUMMARY OF THE INVENTION

### Problems to be Solved by the Invention

However, when the collapsible container is used, there is a potential risk, although rare, that the container could collapse unevenly due to external factors. If the side peripheral portion of the raw water container is deformed by being bumped into something accidentally and the container is mounted as it is, if the raw water container is mounted in a tilted position, or if the raw water container is intensely shaken sideways during use due to earthquake, the container may not collapse evenly in the circumferential direction, but may collapse unevenly with its side peripheral portion being significantly biased in one horizontal direction. This uneven collapsing of the container can be prevented to some extent, by forming folds on the side peripheral portion to control the collapsing of the container. However, the present inventors have found out that, as a result of experiments and trials, it is impossible to completely prevent the uneven collapsing of the container even if the folds are formed on the side peripheral portion. In addition, it has been revealed that, when the uneven collapsing of the container biased to either the right or left side has occurred, the collapsed portion of the container which has been folded in many layers and become rigid could protrude even into spaces behind the front end portions of the side plates of the housing. If such a situation occurs, when the slide table is pulled forward for replacement of the raw water container, the rigid, unevenly collapsed portion of the container could get caught on the front end portions of the side plates of the housing, making it difficult to remove the container.

Therefore, an object of the present invention is to provide a water dispenser which includes the slide table, and in which the raw water container is placed at a position lower than that of the temporary water storage tank, wherein the slide table can be reliably pulled out of the housing when the raw water container is replaced, and wherein the sanitation of the water dispenser can be well maintained.

### Means for Solving the Problems

In order to achieve this object, the present invention provides a water dispenser comprising a temporary water storage tank, a slide table configured to be pulled forward from a drawer space provided at a position lower than that of the temporary water storage tank, a water supply passage through which raw water in a raw water container placed on the slide table can be pumped up to the temporary water storage tank, and a housing containing therein the temporary water storage tank, the slide table, and the water supply passage, wherein the raw water container is a collapsible container comprising a side peripheral portion capable of collapsing naturally as an amount of water remaining in the container decreases, and wherein the housing comprises right and left side plates defining the drawer space, wherein the side plates include front end portions which are bent so as to face each other, wherein the slide table comprises a container supporting portion configured to support a shoulder portion of the raw water container from below, a penetration rod configured to penetrate a plug attached to the neck portion of the raw water container from below upward, and a cover configured to cover the raw water container placed on the container supporting portion from above, the penetration rod is provided with a raw water inlet through which raw water in the raw water container is supplied into the water supply passage, and the cover is configured to guide the side peripheral portion of the raw water container downward from at least both the right and left sides of the raw water container placed on the container supporting portion.

### Effect of the Invention

In the water dispenser having the above constitution, the penetration rod is configured to be inserted into the raw water container from below to allow communication between the raw water container and the water supply passage, and therefore, the cover can be placed over the raw water container placed on the container supporting portion from above. Since the cover covering the raw water container prevents dust from falling in the vicinity of the container supporting portion, the area around the penetration rod is more likely to be kept clean, and the sanitation of the water dispenser can be well maintained. Further, if the side peripheral portion of the raw water container placed on the container supporting portion collapses unevenly, biased to either the right or left side, the cover guides the side peripheral portion of the raw water container downward when it touches the cover. Therefore, it is impossible for the collapsed side peripheral portion of the raw water container to protrude into spaces behind the front end portions of the side plates, and thus the slide table can be pulled out of the housing reliably when the raw water container is replaced. By removing the cover covering the raw water container, a heavy new raw water container can be easily placed on the container supporting portion without lifting it up high. The above arrangement allows for both reducing the workload of the replacement of the container, and guiding the side peripheral portion of the raw water container when the container collapses. Thus, the present invention provides a water dispenser which includes the slide table and in which the raw water container is placed at a position lower than that of the temporary water storage tank, wherein the slide table can be reliably pulled out of the housing when the raw water container is replaced, and wherein the sanitation of the water dispenser can be well maintained.

### BRIEF DESCRIPTION OF THE DRAWINGS

FIG. 1 is a schematic view of an entire water dispenser embodying the present invention.

FIG. 2 is a partial sectional view of the water dispenser shown in FIG. 1, illustrating the state in which a slide table has been pulled out of a housing and a cover has been placed over a raw water container.

FIG. 3 is a partial sectional view showing the structure in the vicinity of a penetration rod shown in FIG. 1.

FIG. 4 is a partial sectional view illustrating the state in which the slide table shown in FIG. 1 has been pulled out of the housing and the cover has been removed.

FIG. 5 is a view illustrating the process in which the side peripheral portion of the raw water container is guided by the cover shown in FIG. 1, when the container collapses.

### MODE FOR CARRYING OUT THE INVENTION

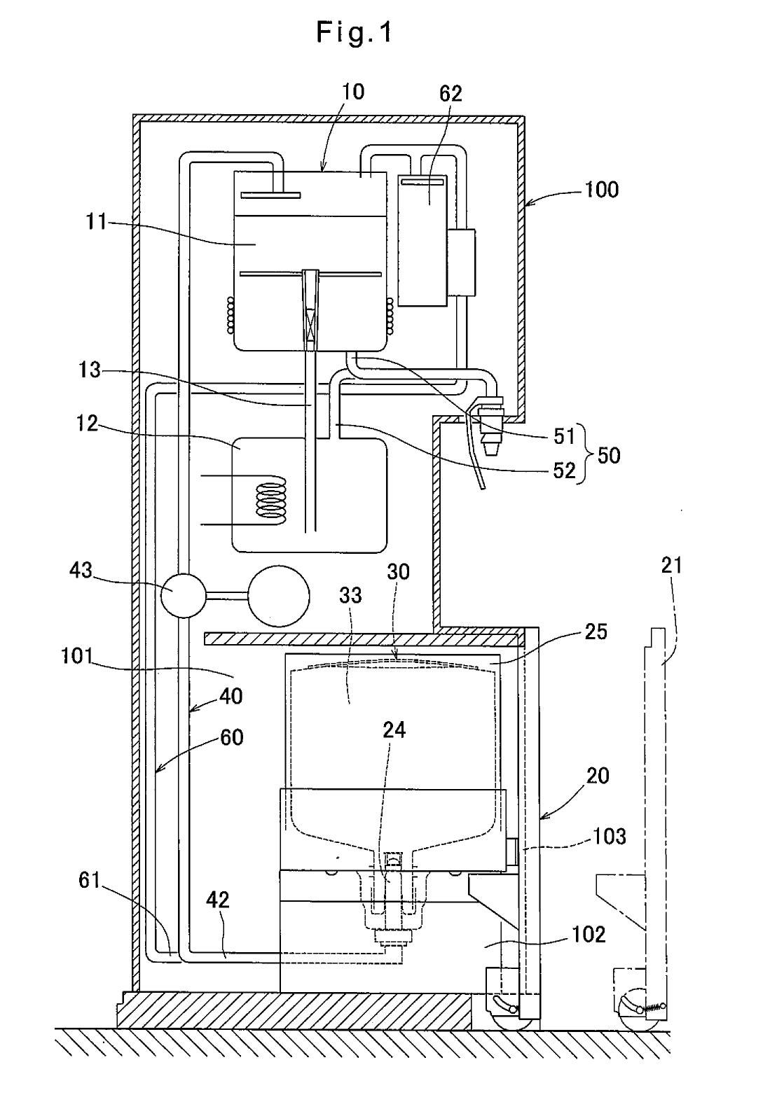

A water dispenser embodying the present invention will now be described with reference to the accompanying drawings. As shown in FIG. 1, this water dispenser includes: temporary water storage tanks 10; a slide table 20 configured to be pulled forward from a drawer space 101 provided at a position lower than that of the temporary water storage tank 10; slide table a water supply passage 40 through which raw water in ae raw water container 30 placed on the slide table 20 can be pumped up to the temporary water storage tank 10; water discharge passages 50 through which water in the respective temporary water storage tanks 10 can be discharged to the exterior of the water dispenser; an air passage 60 which allows communication between the raw water container 30 and atmospheric air; and a housing 100 containing therein the temporary water storage tanks 10, the slide table 20, and the water supply passage 40, water discharge passage 50 and the air passage 60.

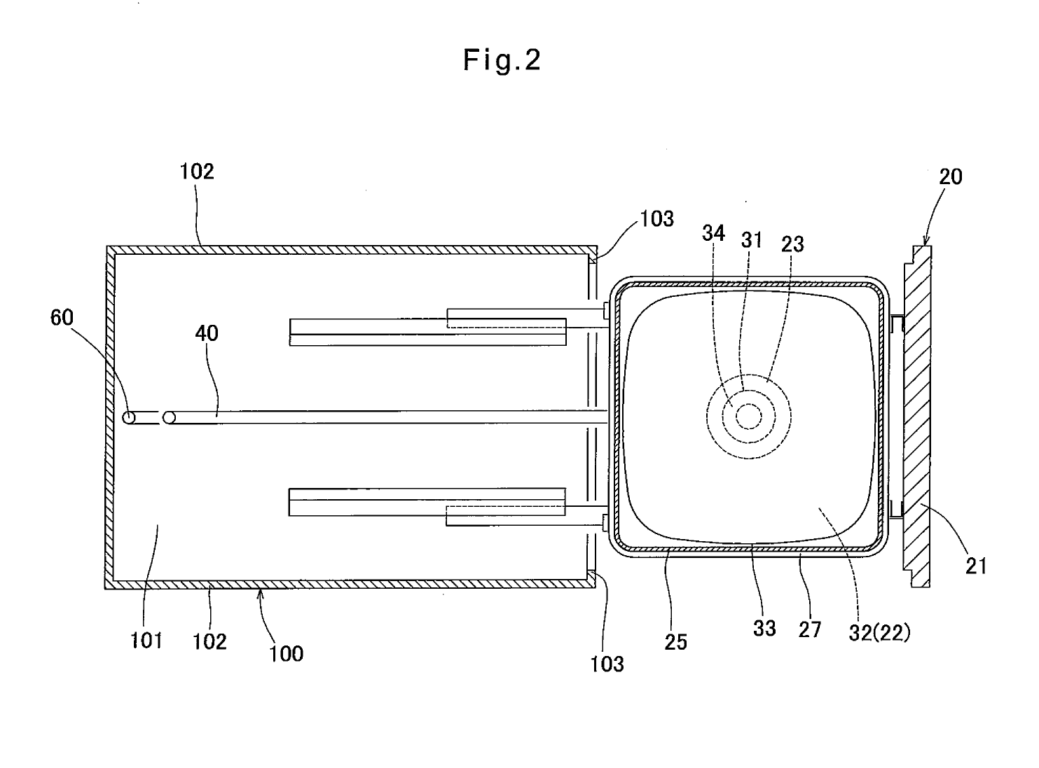

As shown in FIG. 1 and FIG. 2, the housing 100 is an upright machine casing including: right and left side plates 102 defining the drawer space 101; and a top plate, a bottom plate and a front plate which join together the two side plates 102 on both sides; and the like.

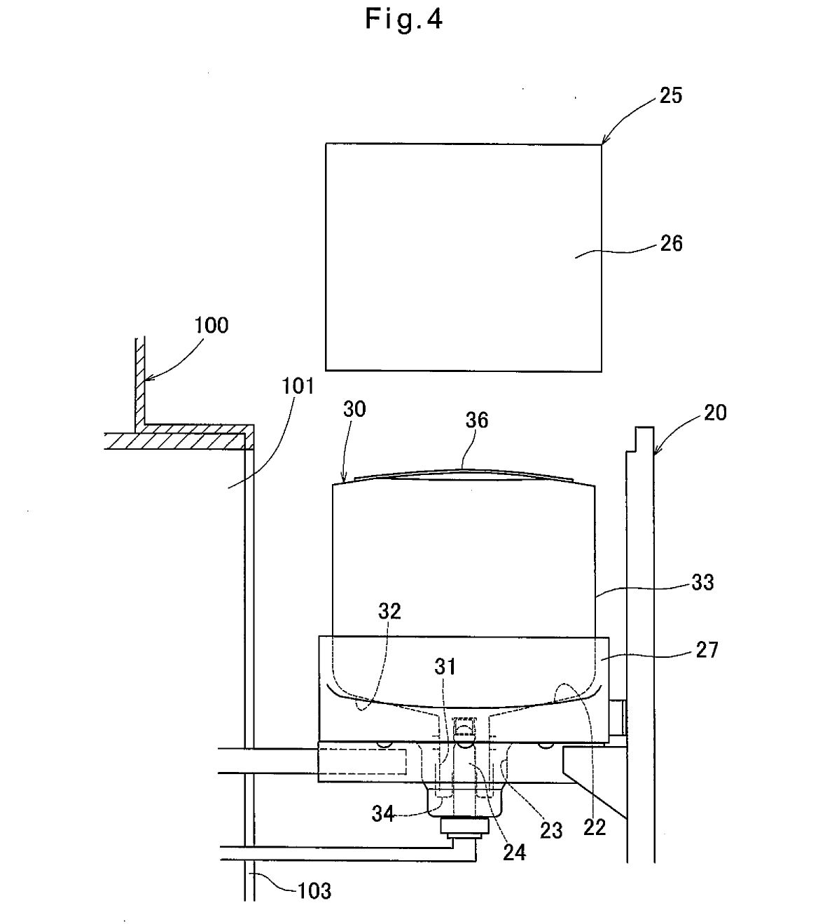

As shown in FIG. 1, FIG. 2, and FIG. 4, the slide table 20 is slidable linearly in a horizontal direction relative to the housing 100, along guide rails provided on the bottom plate of the housing 100. The direction in which the slide table 20 is slid corresponds to the fore and aft direction of the water dispenser, respectively.

The drawer space 101 provided at the lower portion of the housing 100 is closed by a front panel 21′ of the slide table 20. The side plates 102 include front end portions 103 which are bent to face each other from the right and left sides of the housing. The front end portions 103 face the front panel 21 of the slide table 20 in the fore and aft direction.

The temporary water storage tanks 10 shown in FIG. 1 are configured to control the temperature of the water contained therein, and include a cold water tank 11 configured to cool the water contained therein with a heat exchanger, and a hot water tank 12 configured to heat the water contained therein with a heater. The water dispenser further includes a tank connecting passage 13 having an inlet provided at a baffle plate for interfering with the downward flow of the raw water flowing into the cold water tank from the water supply passage 40. Water contained in the upper portion of the cold water tank 11 can flow into the hot water tank 12 through the .tank connecting passage 13. One of the temporary water storage tanks, namely one of the cold water tank and the hot water tank may be dispensed with.

The water discharge passages 50 are passages through which water in the temporary water storage tanks 10 can be discharged. The water discharge passages 50 comprise a cold water discharge passage 51 connected to the cold water tank 11, and a hot water discharge passage 52 provided independently of the cold water discharge passage 51 and connected to the hot water tank 12. When a user opens a valve which serves as a boundary between the cold water discharge passage 51 or the hot water discharge passage 52 and the corresponding temporary water storage tank 10, water contained in the lower portion of the cold water tank 11 or water contained in the upper portion of the hot water tank 12 is discharged through the passage 51 or 52, so that the discharged water can be poured into a cup or the like.

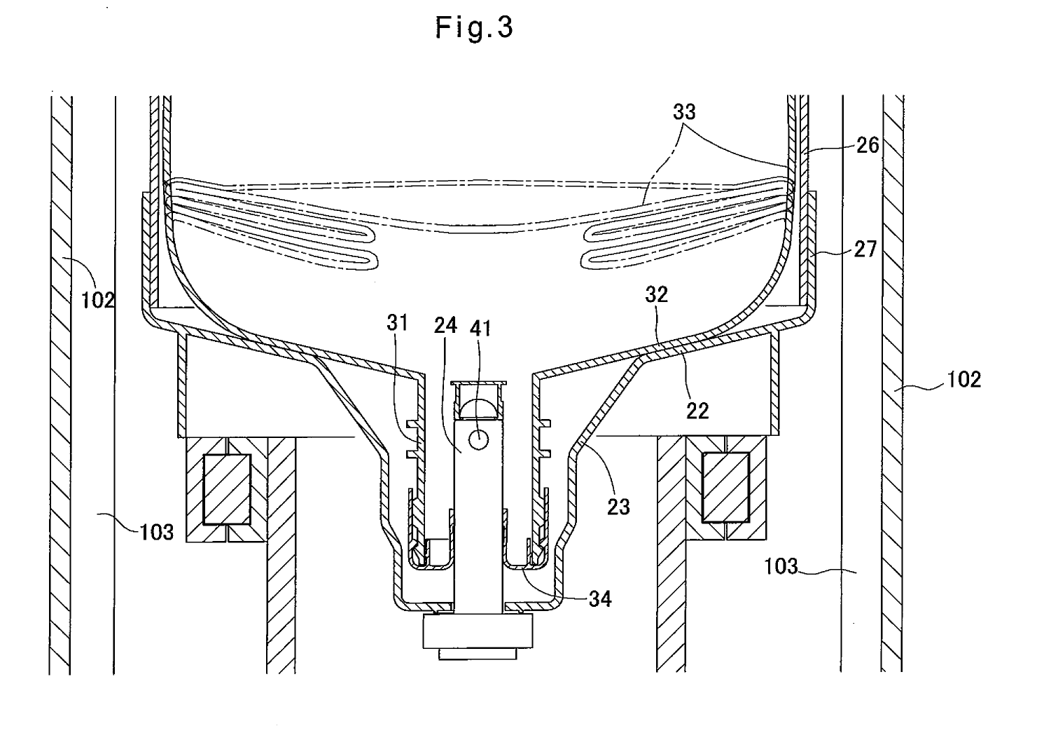

As shown in FIG. 3 and FIG. 4, the raw water container 30 is a collapsible container including a neck portion 31 provided with a container mouth, a shoulder portion 32, a side peripheral portion 33 capable of collapsing naturally as the amount of the water remaining in the container decreases, and a plug 34 attached to the neck portion 31 for sealing the neck portion 31. In addition, the raw water container 30 is provided with a bottom portion 35 so that the container can be placed on a horizontal surface with the container mouth of the neck portion 31 facing upward at the highest position of the raw water container 30. Raw water is introduced into the raw water container 30 through the container mouth provided at the neck portion 31, and the container can be maintained filled with a predetermined amount of water by attaching the plug 34 to the neck portion 31. The shoulder portion 32 of the raw water container is configured to be supported by a portion of the slide table 20 from below, with the raw water container 30 being in the vertically reversed position (with the bottom portion 35 coming to the highest position), until the water in the raw water container 30 is used up to a predetermined level. The shoulder portion 32 is sloped so that raw water in the container collects to the container mouth of the neck portion 31. In order to reduce the amount of water accumulated in the neck portion 31 and to allow press fitting of the plug 34 onto the neck portion in the vertical direction, the neck portion 31 is formed in the shape of a cylinder projecting from the smallest-inner-and-outer-diameter portion of the shoulder portion 32 and having a vertically extending axis. Preferably, the side peripheral portion 33 of the raw water container is provided with folds in order to prevent uneven collapsing of the container. For example, folds extending in the circumferential direction can be provided on the side peripheral portion 33 at regular intervals in the vertical direction so that, as shown in FIG. 3, natural collapsing of the container can be induced in such a manner that the side peripheral portion 33 is folded like a bellows to reduce the volume of the container. Preferably, the rigidity of the bottom portion 35 is increased by forming ribs on, or by increasing the thickness of, the bottom portion 35 so that natural collapsing of the container along the folds is more effectively induced. The container made up of the above-mentioned portions, from the neck portion 31 to the bottom portion 35, can be produced by blow molding of, for example, polyamide (PA) or polyethylene (PET). As shown in FIG. 4, a grip 36 is attached on the bottom portion 35 of the raw water container 30 so that the raw water container 30 can be easily lifted up in the vertically reversed position.

As shown in FIG. 2 and FIG. 3, the slide table 20 includes: a container supporting portion 22 configured to support the shoulder portion 32 of the raw water container 30 from below; a cup portion 23 recessed from the inner periphery of the container supporting portion 22, a penetration rod 24 configured to penetrate the plug 34 from below upward; and a cover 25 configured to cover the raw water container 30 placed on the container supporting portion 22 from above.

The container supporting portion 22 is capable of coming into contact with the shoulder portion 32 in the vertical direction, and supporting the weight of the raw water container 30 from below. Preferably, the rigidity of the shoulder portion 32 is increased by by forming ribs on, or by increasing the thickness, of the shoulder portion 32 so that the shoulder portion 32 remains in contact with the container supporting portion 22, and the raw water container 30 can be held in a stable position, until the raw water in the container is fully used.

The cup portion 23 forms a recess having a depth sufficient to accommodate the neck portion 31 to be inserted from above. The penetration rod 24 is a rod-like member including a tip portion configured to project into the raw water container 30 when the container 30 is placed on the container supporting portion 22; and an outer peripheral sealing surface configured to be brought into close contact with the inner periphery of the plug 34 of the raw water container 30. As shown in FIG. 2, the penetration rod 24 is provided inside the cup portion 23 facing upward at a position corresponding to the geometric center of the container supporting portion 22 and the cup portion 23, which are both formed annularly in plan view. The cup portion 23 is capable of receiving water leaking from between the plug 34 and the penetration rod 24.

The penetration rod 24 is provided with a raw water inlet 41. The interior of the penetration rod 24 is divided into a portion forming one end of the water supply passage 40 and a portion forming one end of the air passage 60. The raw water inlet 41 is an opening through which raw water in the raw water container 30 is supplied into the water supply passage 40 shown in FIG. 1. The penetration rod 24 is also provided with a vent hole (not shown in the figures) through which air taken into the air passage 60 can be released into the raw water container 30. The portion of the water supply passage 40 on the side of the penetration rod 24 is formed into a connecting pipe 42, and the portion of the air passage 60 on the side of penetration rod 24 is formed into a connecting pipe 61, and one end of each of the connecting pipes 42 and 61 communicates with the penetration rod 24. Each of the connecting pipes 42 and 61 is formed of, for example, a flexible pipe which is deformable following the movement of the slide table 20 when the slide table is pulled out of or into the housing. A pump 43 is provided midway in the water supply passage 40. As the pump 43, a plunger pump or a gear pump can be used, for example. The air passage 60 takes in air from an air chamber 62 which is communicated with atmospheric air, and allows communication between the interior of the raw water container 30 and the atmosphere at all times. Therefore, the air chamber 62 is preferably provided with a filter for filtering contaminants such as dust and bacteria in the air, and for deodorizing air.

As shown in FIG. 3 and FIG. 4, the cover 25 is formed in the shape of a box without a bottom, including a top plate configured to cover the raw water container 30 from above, and a peripheral wall 26 extending downward in the vertical direction from the top plate. When the slide table 20 is pulled forward, the entire upper region of the container supporting portion 22 can be moved out of the housing 100. The distal end portion of the peripheral wall 26 can be inserted into and pulled out of a cover receiving portion 27 formed integral with the container supporting portion 22, in the vertical direction. By lifting the raw water container 30 over the container supporting portion 22 in a vertically reversed position, and inserting the neck portion 31 of the raw water container 30 into the cup portion 23 from above, the shoulder portion 32 of the raw water container 30 can be placed on the container supporting portion 22. Since the bottom portion 35, the side peripheral portion 33, the shoulder portion 32 and the neck portion 31, of the raw water container 30 are transparent, it is possible for an operator to visually confirm the position of the penetration rod 24 through the raw water container 30, and to adjust the position of the raw water container 30 in the air such that the plug 34 attached to the neck portion 31 is properly aligned with the penetration rod 24 when placing the raw water container 30 on the container supporting portion 22. As the raw water container 30 is lowered, the penetration rod 24 penetrates the plug 34 from below upward, so that the raw water inlet 41 and the vent hole are allowed to communicate with the interior of the raw water container 30. The outer peripheral sealing surface of the penetration rod 24 is configured to be brought into close contact with the inner periphery of the portion of the plug 34 penetrated by the penetration rod 24, with the plug 34 remaining on the side of the neck portion 31. As shown in FIG. 3, when the shoulder portion 32 of the raw water container 30 is seated on the container supporting portion 22, the mounting of the raw water container 30 is completed. After the completion of the mounting, the edge portion of the peripheral wall 26 of the cover 25 is inserted into the cover receiving portion 27, so that the position of the cover 25 is fixed within the cover receiving portion 27 both vertically and horizontally. In this state, the peripheral wall 26 of the cover 25 surrounds the side peripheral portion 33 of the raw water container 30, as shown in FIG. 1 and FIG. 2, forming a closed chamber in which the raw water container 30 is housed. The purpose of the cover receiving portion 27 is merely to fix the position of the cover 25. Therefore, in cases, as shown in the figures, where the cover receiving portion 27 is formed to extend upward from the outer periphery of the container supporting portion 22, the height of the cover receiving portion 27 extending upward from the outer periphery of the container supporting portion 22 can be set to not more than ⅓ of the height of a new raw water container 30 placed in position.

When the slide table 20 with the cover 25 placed thereover has been pushed rearward to be stowed in the housing 100, and the pump 43 shown in FIG. 1 is turned on, pumping up of water from the raw water container 30 to the temporary water storage tanks 10 through the water supply passage 40 starts for the first time. As the water level in the temporary water storage tanks 10 increases while water is being pumped, air inside the temporary water storage tanks 10 is evacuated through the air chamber 62 communicating with the temporary water storage tanks 10. As the amount of water remaining in the raw water container 30 decreases due to pumping out of water, the pressure inside the raw water container 30 is reduced to a negative pressure relative to the atmospheric pressure. This difference in pressures acts on the side peripheral portion 33, and induces the side peripheral portion 33 to collapse naturally to reduce the volume of the raw water container 30. When the collapsing of the container proceeds as intended, the raw water container collapses naturally and gradually along the folds provided on the side peripheral portion 33. When the water level in one of the temporary water storage tanks 10 shown in FIG. 1, namely, in the tank 11 reaches a predetermined upper limit, the pumping up of water stops automatically. When water in the temporary water storage tanks 10 is discharged through the water discharge passages 50 repeatedly thereafter, and the water level in the temporary water storage tank 11 detected by a water level sensor falls to a predetermined lower limit, the pumping up of water from the raw water container 30 to the temporary water storage tank 10 starts again automatically. As long as the side peripheral portion 33 collapses naturally, the situation in which water in the container is forcibly pumped out by the pump does not occur. However, as the pumping up of water is repeated, the side peripheral portion 33 becomes folded in multiple layers as shown by the alternate long and two short dashed line in FIG. 3, to such an extent that it cannot collapse naturally any further. After the side peripheral portion 33 of the raw water container 30 has become unable to collapse naturally any further, the balancing effect kicks in, in which, as the amount of water remaining in the raw water container 30 shown in FIG. 1 further decreases, air starts to flow into the raw water container 30 through the air passage 60, thus increasing the negative pressure in the raw water container 30. This allows for using up raw water in the raw water container 30 to a predetermined level, without forcibly pumping out the water in the container by the pump 43. As used herein, the situation in which the raw water in the raw water container 30 has been used up to a predetermined level corresponds to the situation in which the level of water remaining in the raw water container 30 has fallen below the position of the raw water inlet 41 shown in FIG. 3.

Since, in this water dispenser, the cover 25 is placed over the raw water container 30 placed on the container supporting portion 22 as shown in FIG. 1, the cover 25 prevents dust from falling in the vicinity of the container supporting portion 22, and thus the area around the penetration rod 24 is more likely to be kept clean. As a result, the sanitation of the water dispenser can be well maintained. In particular, since this water dispenser is configured such that the raw water container 30 is stowed within a closed chamber enclosed by the cover 25 including its peripheral wall 26, the container supporting portion 22, the cup portion 23 and the cover receiving portion 27, as shown in FIG. 1 and FIG. 3, it is more advantageous in terms of maintaining the sanitation of the water dispenser.

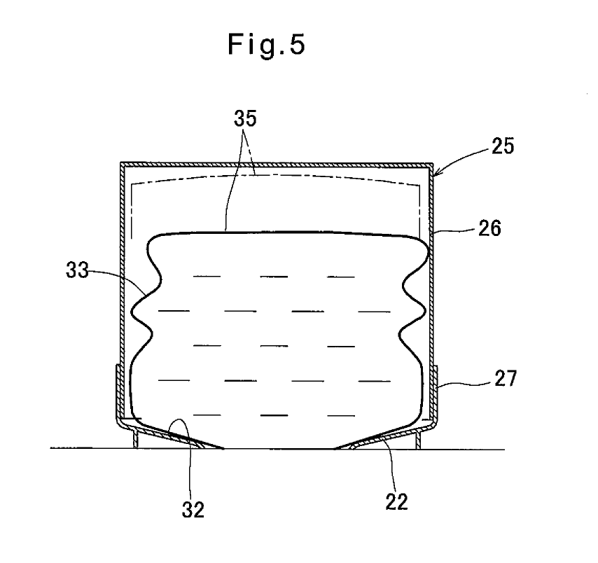

In addition, even if the side peripheral portion 33 is not folded along the folds while it collapses naturally, but collapses unevenly biased to either the right or left, or forward or rearward direction as shown in FIG. 5, due to external factors, it is impossible for the side peripheral portion 33 to be biased any further after it touches the peripheral wall 26 of the cover 25, whose position is fixed by the cover receiving portion 27. Thus, the portion of the side peripheral portion 33 touching the peripheral wall 26 is guided downward by the peripheral wall 26. As shown in FIG. 3, since the peripheral wall 26 of the cover 25 extends below the position of the side peripheral portion 33 capable of collapsing naturally, it is impossible for the side peripheral portion 33 to protrude into spaces behind the front end portions 103 of the side plates 102. Therefore, in this water dispenser, the slide table 20 can be reliably pulled out of the housing, as shown in FIG. 2, when the water in the raw water container 30 shown in FIG. 1 is fully used and the container is replaced with a new one. Further, the cover 25 can be removed from the slide table 20 by lifting the cover 25 upward from the cover receiving portion 27, as shown in FIG. 4, when the raw water container 30 is replaced. Therefore, when a new and heavy raw water container 30 is placed on the container supporting portion 22, it is not necessary to lift it up high. This allows for both reducing the workload required for the replacement of the raw water container 30, and guiding the side peripheral portion 33 of the raw water container 30 when the container collapses.

The scope of the present invention is not limited to the above mentioned embodiments, and includes all of the alterations and variations falling within the technical scope of the claims. For example, as long as the cover 25 is configured to guide the side peripheral portion 33 downward at least from both sides of the raw water container 30 placed on the container supporting portion 22, the slide table 20 can be reliably pulled out of the housing, and therefore, the cover 25 does not need to surround the side peripheral portion 33. Further, in cases where a detachable cover such as the cover 25 is used, it is possible to configure the cover such that a projected portion(s) of the peripheral wall can be inserted into and removed out of a slit-like cover receiving portion. It is also possible to attach the cover 25 to the slide table 20 by hinges or the like, so that it can be opened and closed in one way. In addition, as disclosed in JP 4802299 B, the penetration rod can be configured be elevated and lowered corresponding to the sliding movement of the slide table.

### DESCRIPTION OF SYMBOLS

10 temporary water storage tank

20 slide table

22 container supporting portion

24 penetration rod

25 cover

30 raw water container

31 neck portion

32 shoulder portion

33 side peripheral portion

34 plug

40 water supply passage

41 raw water inlet

100 housing

101 drawer space

102 side plate

103 front end portion

1. A water dispenser comprising:
a housing;
a temporary water storage tank mounted in the housing;
a slide table mounted in the housing and configured to be pulled forward from a drawer space provided at a position lower than the temporary water storage tank;
a water supply passage mounted in the housing and through which raw water in a raw water container placed on the slide table can be pumped up to the temporary water storage tank;
wherein the raw water container is a collapsible container comprising a side peripheral portion capable of collapsing naturally as an amount of water remaining in the container decreases; and
wherein the housing comprises right and left side plates defining the drawer space, wherein the side plates include front end portions which are bent so as to face each other;
wherein the slide table comprises: a container supporting portion configured to support a shoulder portion of the raw water container from below; a penetration rod configured to penetrate a plug attached to the neck portion of the raw water container from below upward; and a cover configured to cover the raw water container placed on the container supporting portion from above;
the penetration rod is provided with a raw water inlet through which raw water in the raw water container is supplied into the water supply passage; and
the cover is configured to guide the side peripheral portion of the raw water Container downward from at least both the right and left sides of the raw water container placed on the container supporting portion.
